(19) United States
(12) Patent Application Publication
(10) Pub. No.: US 2010/0249007 A1
(43) Pub. Date: Sep. 30, 2010

(54) Cleaning Agents

(76) Inventors: Thomas Holderbaum, Hilden (DE); Johannes Zipfel, Düsseldorf (DE)

Correspondence Address: Henkel Corporation, 10 Finderne Avenue, Suite B, Bridgewater, NJ, 08807, US

(21) Appl. No.: 12/813,558

(22) Filed: Jun. 11, 2010

Related U.S. Application Data
(63) Continuation of application No. PCT/EP2008/064970, filed on Nov. 5, 2008.

(30) Foreign Application Priority Data
Dec. 11, 2007 (DE) 10 2007 059 968.6

(51) Int. Cl. C11D 3/395

(52) U.S. Cl. 510/220; 510/367

(57) ABSTRACT

Two-phase or multi-phase washing or cleaning agent comprising a) a bleaching agent, b) a bleach activator, c) a bleach catalyst selected from the group of bleach intensifying transition metal salts and transition metal complexes, wherein bleaching agent a) is present together with at least one of the components b) and c) in a phase of the washing or cleaning agent, the agent having improved cleaning performance, particularly for bleachable stains.

### CROSS REFERENCE TO RELATED APPLICATIONS

The present application is a continuation of International Application No. PCT/EP2008/064970 filed 5 Nov. 2008, which claims priority to German Patent Application No. 10 2007 059 968.6 filed 11 Dec. 2007.

The present patent application describes washing or cleaning agents, in particular cleaning agents for the automatic cleaning of dishes. The present application in particular provides bi- or multiphase automatic dishwashing agents which contain bleach catalysts.

Today, more stringent requirements are often applied to machine washed dishes than to hand washed dishes. For example, a dish which first appears to be completely clean of food residues is not considered clean if it still exhibits discoloration after automatic dishwashing due to, for example, deposition of vegetable dyes onto the surface of the dish.

To achieve spotless dishes, bleaching agents are used in automatic dishwashing agents. To activate these bleaching agents and achieve improved bleaching action at temperatures of 60° C. and below, automatic dishwashing agents generally additionally contain bleach activators or bleach catalysts, with bleach catalysts having proven particularly effective.

European patent application EP 481 793 A1 (Unilever) discloses cleaning agent tablets containing sodium percarbonate which, according to the teaching of said application, is preferably formulated separately from other components detrimental to the stability thereof, for example, in a separate layer.

Bleach catalysts are used in automatic dishwashing agents preferably in the form of premanufactured granules. For example, European patents EP 458 397 B1 (Unilever), EP 458 398 B1 (Unilever) and EP 530 870 B1 (Unilever) describe bleach catalysts based on various manganese-containing transition metal complexes.

Methods for producing bleach catalyst granules are disclosed in published patent applications EP 544 440 A2 (Unilever) and WO 95/06710 A1 (Unilever). A distinguishing feature of the method described therein is the use of large quantities of binder, optionally used in the form of melts, said procedure involving cooling and/or drying stages which require the use of additional apparatuses such as fluidized bed installations.

Still, despite their undisputed bleaching action, use of bleach catalysts cannot be considered satisfactory in every respect for a person skilled in the art. For instance, even with use of bleach catalysts, unexpectedly poor bleaching action is frequently observed, particularly in low-alkali, for example, phosphate-free automatic dishwashing agents Furthermore, storage stability of cleaning agents containing bleach catalysts frequently leaves something to be desired.

In the light of this initial situation, the present application provides an automatic dishwashing agent which exhibits improved cleaning performance, particularly on bleachable soiling.

It has surprisingly been found that the bleaching action of automatic dishwashing agents can be increased by formulating active ingredient combinations of bleaching agent, bleach activator and bleach catalyst in bi- or multiphase dispensing units with an optimized phase split.

The present application accordingly firstly provides a bi- or multiphase washing or cleaning agent comprising—
a) a bleaching agent,
b) a bleach activator, and
c) a bleach catalyst chosen from bleach-boosting transition metal salts and transition metal complexes,
   wherein bleaching agent a) is present together with at least one of components b) or c) in one phase of the washing or cleaning agent.

As stated above, in the bi- or multiphase washing or cleaning agents according to the invention bleaching agent a) is present together with at least one of components b) and c) in one phase of the washing or cleaning agent. The application accordingly provides not only bi- or multiphase washing or cleaning agents wherein part or all of bleaching agent a) is present together with a portion of one of components b) and c) in one phase, but also bi- or multiphase washing or cleaning agents wherein the total quantity of bleaching agent a) is present together with all of at least one of components b) or c) in one phase.

The application accordingly preferably provides—

A bi- or multiphase washing or cleaning agent comprising
a) a bleaching agent,
b) a bleach activator, and
c) a bleach catalyst chosen from bleach-boosting transition metal salts and transition metal complexes,
   wherein a portion of bleaching agent a) is present together with a portion of at least one of components b) or c) in one phase of the washing or cleaning agent.

A bi- or multiphase washing or cleaning agent comprising
a) a bleaching agent
b) a bleach activator
c) a bleach catalyst chosen from bleach-boosting transition metal salts and transition metal complexes,
   wherein the total quantity of bleaching agent a) is present together with a portion of at least one of components b) or c) in one phase of the washing or cleaning agent.

A bi- or multiphase washing or cleaning agent comprising
a) a bleaching agent,
b) a bleach activator, and
c) a bleach catalyst chosen from bleach-boosting transition metal salts and transition metal complexes,
   wherein the total quantity of bleaching agent a) is present together with the total quantity of at least one of components b) or c) in one phase of the washing or cleaning agent

It has proven particularly advantageous to formulate as large as possible a portion of the bleaching agent a) together in one phase with as large as possible a portion of one of components b) or c). Preferred bi- or multiphase washing or cleaning agents are therefore characterized in that at least 50 wt. %, preferably at least 70 wt. %, particularly preferably at least 90 wt. % and in particular the total quantity of the bleaching agent a) contained in the bi- or multiphase washing or cleaning agent is formulated in one phase together with at least 50 wt. %, preferably at least 70 wt. %, particularly preferably at least 90 wt. % and in particular the total quantity of one of components b) or c).

The application accordingly particularly preferably provides—

A bi- or multiphase washing or cleaning agent comprising
a) a bleaching agent,
b) a bleach activator, and
c) a bleach catalyst chosen from bleach-boosting transition metal salts and transition metal complexes,
   wherein at least 50 wt. %, preferably at least 70 wt. %, particularly preferably at least 90 wt. % and in particular all of bleaching agent a) is formulated in one phase together with at least 50 wt. %, preferably at least 70 wt. %, particularly preferably at least 90 wt. % and in particular all of one of components b) or c).

A bi- or multiphase washing or cleaning agent comprising
a) a bleaching agent,
b) a bleach activator, and
c) a bleach catalyst chosen from bleach-boosting transition metal salts and transition metal complexes,
   wherein at least 50 wt. %, preferably at least 70 wt. %, particularly preferably at least 90 wt. % and in particular all of bleaching agent a) is formulated in one phase together with at least 50 wt. %, preferably at least 70 wt. %, particularly preferably at least 90 wt. %, and particularly all of one of components b) or c), while the second component b) or c) is separately formulated in a separate phase.

According to the invention, multiphase washing or cleaning agents contain as a first component a bleaching agent, with oxygen bleaching agents being preferred. Among those compounds acting as bleaching agents which release H₂O₂ in water, sodium percarbonate, sodium perborate tetrahydrate and sodium perborate monohydrate are of particular significance. Further usable bleaching agents include peroxypyrophosphates, citrate perhydrates and H₂O₂-releasing per-acidic salts or per-acids such as perbenzoates, peroxophthalates, diperazelaic acid, phthaloimino per-acid or diperdodecanedioic acid.

Organic bleaching agents can also be used. Typical organic bleaching agents include diacyl peroxides such as dibenzoyl peroxide. Further typical organic bleaching agents include peroxy acids such as alkylperoxy acids and arylperoxy acids.

Preferred bi- or multiphase washing or cleaning agents include those wherein bleaching agent a) is an oxygen bleaching agent, preferably sodium percarbonate, particularly preferably a coated sodium percarbonate.

Preferably, bleaching agent a) in present in the washing or cleaning agents in an amount of 2 to 30 wt. %, preferably 4 to 20 wt. % and particularly 6 to 15 wt. %, based on total weight of the agent.

Bi- or multiphase washing or cleaning agents according to the invention contain bleach activators as a second component. Useful bleach activators include compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Polyacylated alkyl enediamines are preferred, tetraacetylethylenediamine (TAED) having proved particularly suitable.

Bi- or multiphase washing or cleaning agents wherein bleach activator b) is acetylated amines, preferably tetraacetylethylenediamine (TAED), are preferred according to the invention.

These bleach activators, in particular TAED, are preferably used in quantities of up to 10 wt. %, in particular 0.1 wt. % to 10 wt. %, particularly 0.5 to 8 wt. % and particularly preferably 1.0 to 6 wt. %.

Bi- or multiphase washing or cleaning agents are preferred wherein bleach activator b) is present in an amount of from 0.1 to 10 wt. %, preferably 0.5 to 8 wt. % and particularly 1.0 to 6 wt. %, based on total weight of the agent.

Preferably, bleach activator b) is in granule or particulate form, those particles having a bleach activator content of 80 wt. % or greater. Regarding the above-described bleaching action, it has proven advantageous to have the highest possible bleach activator content in the granules.

Preferred bi- or multiphase washing or cleaning agents according to the invention contain bleach activator b) in the form of particles having a bleach activator content of 85 wt. % or greater, preferably 90 wt. % or greater, particularly preferably 95 wt. % or greater, and particularly 97 wt. % or greater.

Concerning active ingredients and auxiliaries present in the bleach activator particles in addition to the bleach activator, it has in particular proven advantageous to limit the content of polymeric granulation auxiliaries and stabilizers.

Polymeric granulation auxiliaries here includes natural, but in particular synthetic, organic polymers, for example, polymeric polycarboxylates or polymeric polysulfonates. Stabilizers in particular include phosphonates described in greater detail below.

Preferred bi- or multiphase washing or cleaning agents according to the invention include bleach activator b) in the form of particles having less than 20 wt. %, preferably less than 15 wt. %, particularly preferably less than 10 wt. % and in particular less than 5 wt. % of a polymeric granulation auxiliary, based on total weight of the granule.

Preferred bi- or multiphase washing or cleaning agents according to the invention further contain bleach activator b) in the form of particles containing less than 20 wt. %, preferably less than 15 wt. %, particularly preferably less than 10 wt. % and in particular less than 5 wt. % of stabilizing additions, based on total weight of the granule.

In addition to conventional bleach activators, the washing or cleaning agents according to the invention contain at least one bleach catalyst c) as a third component. These substances include bleach-boosting transition metal salts or transition metal complexes such as Mn, Fe, Co, Ru or Mo salt complexes or carbonyl complexes. Mn, Fe, Co, Ru, Mo, Ti, V and Cu complexes with nitrogenous tripod ligands and Co, Fe, Cu and Ru ammine complexes can also be used as bleach catalysts.

Manganese complexes in oxidation state II, III, IV or IV preferably having one or more macrocyclic ligand(s) with N, NR, PR, O and/or S donor functions are particularly preferentially used. Ligands having nitrogen donor functions are preferably used. It is particularly preferably to use bleach catalyst(s) containing as macromolecular ligands 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes include [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂ (OAc═OC(O)CH₃).

Automatic dishwashing agents which further contain a bleach catalyst chosen from bleach-boosting transition metal salts and transition metal complexes, preferably from manganese complexes with 1,4,7-trimethyl-1,4,7-triazacyclononane (Me₃-TACN) or 1,2,4,7-tetramethyl-1,4,7-triazacyclononane (Me₄-TACN), are preferred according to the invention since the above-stated bleach catalysts can bring about a significant improvement in the cleaning result.

Bi- or multiphase washing or cleaning agents wherein bleach catalyst c) is a manganese complex, preferably from manganese complexes with 1,4,7-trimethyl-1,4,7-triazacyclononane (Me₃-TACN) or 1,2,4,7-tetramethyl-1,4,7-triazacyclononane (Me₄-TACN) are preferred according to the invention.

The above bleach-boosting transition metal complexes, in particular with Mn and Co central atoms, are used in conventional quantities, preferably in a quantity of up to 5 wt. %, in particular 0.0025 wt. % to 1 wt. % and particularly preferably 0.01 wt. % to 0.30 wt. %, based on total weight of the agents containing bleach catalyst. In certain cases, however, more bleach catalyst may also be used.

Bi- or multiphase washing or cleaning agents wherein the amount of bleach catalyst c) is from 0.001 to 3.0 wt. %, preferably 0.01 to 2.0 wt. % and particularly 0.01 to 1.0 wt. %, based on total weight of the agent, are preferred according to the invention.

Example formulations of preferred bi- or multiphase washing or cleaning agents are illustrated in the following tables—

| | Formula- | Formula- | Formula- | Formu- |
|---|---|---|---|---|
| | tion 1 | tion 2 | tion 3 | lation 4 |
| Ingredient | [wt. %] | [wt. %] | [wt. %] | [wt. %] |
| Oxygen bleaching | 2 to 30 | 4 to 20 | 4 to 20 | 6 to 15 |
| agent | | | | |
| Bleach activator | 0.1 to 10 | 0.5 to 8 | 0.5 to 8 | 1 to 6 |
| Bleach catalyst | 0.001 to 3 | 0.001 to 3 | 0.01 to 2 | 0.01 to |
| | | | | 1.0 |
| | Formula- | Formula- | Formula- | Formu- |
| | tion 5 | tion 6 | tion 7 | lation 8 |
| Ingredient | [wt. %] | [wt. %] | [wt. %] | [wt. %] |
| Sodium percarbonate | 2 to 30 | 4 to 20 | 4 to 20 | 6 to 15 |
| Bleach activator | 0.1 to 10 | 0.5 to 8 | 0.5 to 8 | 1 to 6 |
| Bleach catalyst | 0.001 to 3 | 0.001 to 3 | 0.01 to 2 | 0.01 to |
| | | | | 1.0 |
| | | | | Formu- |
| | Formula- | Formula- | Formula- | lation |
| | tion 9 | tion 10 | tion 11 | 12 |
| Ingredient | [wt. %] | [wt. %] | [wt. %] | [wt. %] |
| Sodium percarbonate | 2 to 30 | 4 to 20 | 4 to 20 | 6 to 15 |
| TAED | 0.1 to 10 | 0.5 to 8 | 0.5 to 8 | 1 to 6 |
| Bleach catalyst | 0.001 to 3 | 0.001 to 3 | 0.01 to 2 | 0.01 to |
| | | | | 1.0 |
| | | | | Formu- |
| | Formula- | Formula- | Formula- | lation |
| | tion 13 | tion 14 | tion 15 | 16 |
| Ingredient | [wt. %] | [wt. %] | [wt. %] | [wt. %] |
| Sodium percarbonate | 2 to 30 | 4 to 20 | 4 to 20 | 6 to 15 |
| TAED | 0.1 to 10 | 0.5 to 8 | 0.5 to 8 | 1 to 6 |
| Mn-Me₃-TACN | 0.001 to 3 | 0.001 to 3 | 0.01 to 2 | 0.01 to |
| complex | | | 1.0 | |

As stated above, bi- or multiphase washing or cleaning agents according to the invention are characterized in that the bleaching agent a) is present together with at least one of components b) and c) in one phase of the washing or cleaning agent.

A first preferred embodiment of washing or cleaning agents according to the invention is characterized in that the bleaching agent a) is present together with the bleach activator b) in one phase of the washing or cleaning agent.

Example formulations of preferred bi- or multiphase washing or cleaning agents are illustrated in the following tables—

| | Formula- | Formula- | Formula- | Formula- |
|---|---|---|---|---|
| | tion 17 | tion 18 | tion 19 | tion 20 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] * | | | | |
| Bleach activator [1] | 0.1 to 10 | 0.5 to 8 | 0.5 to 8 | 1 to 6 |
| Bleach catalyst [2] ** | 0.001 to 3 | 0.001 to 3 | 0.01 to 2 | 0.01 to 1.0 |

* [1] = phase 1 (in this and all the following tables)
** [2] = phase 2 (in this and all the following tables)

(Unless otherwise stated in the following tables, the proportions by weight listed are the total quantities of the components present in the bi- or multiphase washing or cleaning agent.)

| | Formula- | Formula- | Formula- | Formula- |
|---|---|---|---|---|
| | tion 21 | tion 22 | tion 23 | tion 24 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| | Formula- | Formula- | Formula- | Formula- |
| | tion 25 | tion 26 | tion 27 | tion 28 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| | Formula- | Formula- | Formula- | Formula- |
| | tion 29 | tion 30 | tion 31 | tion 32 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [1] | 0.1 to 10 | 0.5 to 8 | 0.5 to 8 | 1 to 6 |
| Mn-Me₃-TACN | 0.001 to 3 | 0.001 to 3 | 0.01 to 2 | 0.01 to 1.0 |
| complex [2] | | | | |

A second preferred embodiment of washing or cleaning agents according to the invention is characterized in that the bleaching agent a) is present together with the bleach catalyst c) in one phase of the washing or cleaning agent.

Example formulations of preferred bi- or multiphase washing or cleaning agents are illustrated in the following tables—

| | Formula- | Formula- | Formula- | Formula- |
|---|---|---|---|---|
| | tion 33 | tion 34 | tion 35 | tion 36 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] * | | | | |
| Bleach activator [2] | 0.1 to 10 | 0.5 to 8 | 0.5 to 8 | 1 to 6 |
| Bleach catalyst [1] ** | 0.001 to 3 | 0.001 to 3 | 0.01 to 2 | 0.01 to 1.0 |
| | Formula- | Formula- | Formula- | Formula- |
| | tion 37 | tion 38 | tion 39 | tion 40 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| | Formula- | Formula- | Formula- | Formula- |
| | tion 42 | tion 42 | tion 43 | tion 44 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| | Formula- | Formula- | Formula- | Formula- |
| | tion 45 | tion 46 | tion 47 | tion 48 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [2] | 0.1 to 10 | 0.5 to 8 | 0.5 to 8 | 1 to 6 |
| Mn-Me₃-TACN | 0.001 to 3 | 0.001 to 3 | 0.01 to 2 | 0.01 to 1.0 |
| complex [1] | | | | |

A third preferred embodiment of washing or cleaning agents according to the invention is characterized in that the bleaching agent a) is present together with the bleach activator b) and the bleach catalyst c) in one phase of the washing or cleaning agent.

Example formulations of preferred bi- or multiphase washing or cleaning agents are illustrated in the following tables—

| | | | | Formu- |
|---|---|---|---|---|
| | Formula- | Formula- | Formula- | lation |
| | tion 49 | tion 50 | tion 51 | 52 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to |
| | | | | 1.0 |
| | | | | Formu- |
| | Formula- | Formula- | Formula- | lation |
| | tion 53 | tion 54 | tion 55 | 56 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to |
| | | | | 1.0 |
| | | | | Formu- |
| | Formula- | Formula- | Formula- | lation |
| | tion 57 | tion 58 | tion 59 | 60 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to |
| | | | | 1.0 |
| | | | | Formu- |
| | Formula- | Formula- | Formula- | lation |
| | tion 61 | tion 62 | tion 63 | 64 |
| Ingredient [phase] | [wt. %] | [wt. %] | [wt. %] | [wt. %] |
| Sodium percarbonate [1] | 2 to 30 | 4 to 20 | 4 to 20 | 6 to 15 |
| TAED [1] | 0.1 to 10 | 0.5 to 8 | 0.5 to 8 | 1 to 6 |
| Mn-Me₃-TACN | 0.001 to 3 | 0.001 to 3 | 0.01 to 2 | 0.01 to |
| complex [1] | | | | 1.0 |

In addition to the previously described ingredients, agents according to the invention can contain further substances with a washing or cleaning action, preferably builders, surfactants, polymers, enzymes, glass corrosion inhibitors, corrosion inhibitors, disintegration auxiliaries, scents and perfume carriers. These preferred ingredients are described in greater detail below.

Builders include zeolites, silicates, carbonates, organic cobuilders and, where there is no environmental restriction against their use, phosphates.

Crystalline layered silicates of the general formula NaMSiₓO₂ₓ₊₁.yH₂O, wherein M is sodium or hydrogen, x is a number from 1.9 to 22, preferably from 1.9 to 4, particularly preferred values for x being 2, 3 or 4, and y is a number from 0 to 33, preferably from 0 to 20, are preferentially used.

Washing or cleaning agents preferably contain a proportion by weight of the crystalline layered silicate of the formula NaMSiₓO₂ₓ₊₁.yH₂O of 0.1 to 20 wt. %, preferably 0.2 to 15 wt. % and particularly 0.4 to 10 wt. %, based on total weight of these agents.

Amorphous sodium silicates can also be used which have an Na₂O:SiO₂ modulus of 1:2 to 1:3.3, preferably 1:2 to 1:2.8 and in particular 1:2 to 1:2.6, which are preferably dissolution-retarded and exhibit secondary washing characteristics.

Preferred washing or cleaning agents contain no water-insoluble aluminum silicates such as natural or synthetic zeolites used for water softening.

For the purposes of the present invention, it is preferred for this/these silicate(s), preferably alkali metal silicates, particularly preferably crystalline or amorphous alkali metal disilicates, to be present in washing or cleaning agents in quantities of 3 to 60 wt. %, preferably 8 to 50 wt. % and in particular 20 to 40 wt. %, based on weight of the washing or cleaning agent.

Generally known phosphates can also be used as builder substances, provided that such use is permitted on environmental grounds. Among the numerous commercially obtainable phosphates, alkali metal phosphates have the greatest significance in the washing and cleaning agents industry, with pentasodium or pentapotassium triphosphate (sodium or potassium tripolyphosphate) being particularly preferred.

If phosphates are used in the washing or cleaning agents, preferred agents contain this/these phosphate(s), preferably alkali metal phosphate(s), particularly preferably pentasodium or pentapotassium triphosphate (sodium or potassium tripolyphosphate), in quantities of 5 to 80 wt. %, preferably 15 to 75 wt. % and in particular 20 to 70 wt. %, based on total weight of the washing or cleaning agent.

Washing or cleaning agents according to the invention contain at least one polymer having acid groups acting as a water-softening agent as a further preferred component. The polymer containing acid groups comprises at least one monomer containing acid groups and optionally further nonionic, preferably hydrophobic, monomer(s).

The proportion by weight of this polymer or these polymers relative to total weight of the automatic dishwashing agent is preferably 0.1 to 30 wt. %, preferably 0.5 to 25 wt. % and in particular 1.0 to 20 wt. %.

Washing or cleaning agents which, relative to the total weight thereof, contain 0.1 to 30 wt. %, preferably 0.5 to 25 wt. % and in particular 1.0 to 20 wt. % of copolymer(s) comprising:

i) at least one monomer containing acid groups, and

ii) optionally further nonionic, preferably hydrophobic monomer(s) are preferred according to the invention.

With regard to improving bleaching performance, those copolymers in which monomer i) containing acid groups comprises a carboxylic acid group and/or a sulfonic acid group have proven particularly effective.

Unsaturated carboxylic acids i) used with particular preference in these special copolymers (c) include unsaturated carboxylic acids of the formula R¹(R²)C═C(R³)COOH, wherein R¹ to R³ are mutually and independently —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH as defined above or are —COOH or —COOR⁴, R⁴ being a saturated or unsaturated, straight-chain or branched hydrocarbon residue with 1 to 12 carbon atoms.

Particularly preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof.

In a preferred embodiment, in addition to at least one monomer containing carboxylic acid groups, the copolymers furthermore comprise at least one additional ionic monomer.

A first group of preferred washing or cleaning agents contain copolymer(s) comprising:

i) monomers from the group of mono- or polyunsaturated carboxylic acids, and

ii) optionally further nonionic, preferably hydrophobic monomer(s).

A second group of preferred washing or cleaning agents contain copolymer(s) comprising:

i) monomers from the group of mono- or polyunsaturated sulfonic acids, and

ii) optionally further nonionic, preferably hydrophobic monomer(s).

These preferred copolymers containing sulfonic acid groups contain as monomer i) monomers preferably containing sulfonic acid groups of the formula R⁵(R⁶)C═C(R⁷)—X—SO₃H, wherein R⁵ to R⁷ are mutually and independently —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or are —COOH or —COOR⁴, R⁴ being a saturated or unsaturated, straight-chain or branched hydrocarbon residue with 1 to 12 carbon atoms, and X denotes an optionally present spacer group, which is selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Preferred among these monomers are those of formulae—

H₂C═CH—X—SO₃H

H₂C═C(CH₃)—X—SO₃H

HO₃S—X—(R⁶)C═C(R⁷)—X—SO₃H,

wherein R⁶ and R⁷ are mutually and independently —H, —CH₃, —CH₂CH₃, —CH₂CH₂CH₃, or —CH(CH₃)₂; and X is an optionally present spacer group chosen from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups include 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

Sulfonic acid groups can be present in the polymers in partially or entirely neutralized form (i.e., the acidic hydrogen atom of the sulfonic acid group may be replaced in some or all of the sulfonic acid groups with metal ions, preferably alkali metal ions and in particular with sodium ions).

Preferably, copolymers containing partially or completely neutralized sulfonic acid groups are used.

In those copolymers solely containing monomers from groups i) and ii), the monomer distribution of the copolymers is preferably 5 to 95 wt. % of i) or ii), particularly preferably 50 to 90 wt. % of monomer from group i) and 10 to 50 wt. % of monomer from group ii), based on weight of the polymer.

Molar mass of sulfa copolymers preferably used according to the invention can be varied in order to tailor the properties of the polymers to the desired intended application. Preferred automatic dishwashing agents include copolymers having molar masses of 2000 to 200,000 gmol⁻¹, preferably 4000 to 25,000 gmol⁻¹ and in particular 5000 to 15,000 gmol⁻¹.

In a first preferred embodiment, in addition to at least one monomer containing sulfonic acid groups, the copolymers furthermore comprise at least one additional ionic monomer.

Polymers containing acid groups preferably contain as further nonionic, preferably hydrophobic monomer(s), monomers of the general formula R¹(R²)C═C(R³)—X—R⁴, wherein R¹ to R³ are mutually and independently —H, —CH₃ or —C₂H₅, X is an optionally present spacer group chosen from —CH₂—, —C(O)O— and —C(O)—NH—, and R⁴ is a straight-chain or branched saturated alkyl residue with 2 to 22 carbon atoms, or is an unsaturated, preferably aromatic residue with 6 to 22 carbon atoms.

Particularly preferred unsaturated hydrocarbon residues include butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins with 10 or more carbon atoms such as for example 1-decene, 1-dodecene, 1-hexadecene, 1-octadecene and C₂₂-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

Example formulations of preferred bi- or multiphase washing or cleaning agents containing polymers are illustrated in the following tables—

| | Formula- | Formula- | Formula- | Formula- |
|---|---|---|---|---|
| | tion 65 | tion 66 | tion 67 | tion 68 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Polymer containing acid | 0.1 to 30 | 0.5 to 25 | 1 to 20 | 1 to 20 |
| groups* | | | | |
| | Formula- | Formula- | Formula- | Formula- |
| | tion 69 | tion 70 | tion 71 | tion 72 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Polymer containing acid | 0.1 to 30 | 0.5 to 25 | 1 to 20 | 1 to 20 |
| groups* | | | | |
| | Formula- | Formula- | Formula- | Formula- |
| | tion 73 | tion 74 | tion 75 | tion 76 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.1 to 1.0 |
| Polymer containing acid | 0.1 to 30 | 0.5 to 25 | 1 to 20 | 1 to 20 |
| groups* | | | | |

*copolymer(s) comprising
i) at least one monomer containing acid groups, and
ii) optionally further nonionic, preferably hydrophobic monomer(s) as a component of phases [1] and/or [2] and/or of one or more further phases.

Alkalinity donors are further builders. Substances deemed alkalinity donors include alkali metal hydroxides, alkali metal carbonates, alkali metal hydrogencarbonates, alkali metal sesquicarbonates, the stated alkali metal silicates, alkali metal metasilicates, and mixtures of the above-stated substances, with alkali metal carbonates, in particular sodium carbonate, sodium hydrogencarbonate or sodium sesquicarbonate, preferably being used for the purposes of the present invention. A builder system containing a mixture of tripolyphosphate and sodium carbonate is particularly preferred. A builder system containing a mixture of tripolyphosphate and sodium carbonate and sodium disilicate is likewise particularly preferred. Due to their low level of chemical compatibility with other ingredients in washing or cleaning agents compared to other builder substances, alkali metal hydroxides are preferably used only in small quantities, preferably in quantities of less than 10 wt. %, preferably below 6 wt. %, particularly preferably below 4 wt. % and in particular below 2 wt. %, based on total weight of the washing or cleaning agent. Particularly preferred agents are those having less than 0.5 wt. %, particularly no alkali metal hydroxides, based on total weight of the agent.

It is particularly preferred to use carbonate(s) and/or hydrogencarbonate(s), preferably alkali metal carbonate(s), particularly preferably sodium carbonate, in quantities of 2 to 50 wt. %, preferably 5 to 40 wt. % and in particular 7.5 to 30 wt. %, based on weight of the washing or cleaning agent. Particularly preferred agents contain, based on weight of the washing or cleaning agent, less than 20 wt. %, preferably less than 17 wt. %, preferably less than 13 wt. % and in particular less than 9 wt. % of carbonate(s) and/or hydrogencarbonate(s), preferably alkali metal carbonate(s), particularly preferably sodium carbonate.

Organic cobuilders include polycarboxylates/polycarboxylic acids, polymeric polycarboxylates, aspartic acid, polyacetals, dextrins, further organic cobuilders and phosphonates. These classes of substances are described below.

Usable organic builder materials include polycarboxylic acids usable in the form of the free acid and/or the sodium salts thereof, polycarboxylic acids being those carboxylic acids having more than one acid function. These include citric acid, adipic acid, succinic acid, glutaric acid, malic acid, tartaric acid, maleic acid, fumaric acid, saccharic acids, aminocarboxylic acids, nitrilotriacetic acid (NTA), provided that there are no environmental restrictions, together with mixtures thereof. Apart from their builder action, free acids typically also have the property of an acidifying component and so also serve to establish a lower and gentler pH value for washing or cleaning agents. Citric acid, succinic acid, glutaric acid, adipic acid, gluconic acid and any desired mixtures of these may in particular be mentioned.

Further suitable builders are polymeric polycarboxylates, for example, the alkali metal salts of polyacrylic acid or polymethacrylic acid, for example, those with a relative molecular mass of 500 to 70000 g/mol.

Molar masses indicated for polymeric polycarboxylates refer to for the purposes of this document weight-average molar masses M_{w} of the respective acid form, determined by gel permeation chromatography (GPC) using a UV detector. Measurement was made relative to an external polyacrylic acid standard, supplying realistic molecular weight values as a result of its structural relatedness to polymers under investigation. These values differ markedly from molecular weight values in which polystyrenesulfonic acids are used as the standard. Molar masses measured relative to polystyrenesulfonic acids are generally markedly higher than molar masses indicated in the present document.

Suitable polymers are in particular polyacrylates, which preferably have a molecular mass of 2000 to 20000 g/mol. Due to their superior solubility, short-chain polyacrylates from this group may in turn be preferred having molar masses of from 2000 to 10000 g/mol, and particularly preferably from 3000 to 5000 g/mol.

Also suitable are copolymeric polycarboxylates, in particular those of acrylic acid with methacrylic acid and acrylic acid or methacrylic acid with maleic acid. Copolymers of acrylic acid with maleic acid containing 50 to 90 wt. % acrylic acid and 50 to 10 wt. % maleic acid have proven particularly suitable. Their relative molecular mass, relative to free acids, amounts in general to 2000 to 70,000 μmol, preferably 20,000 to 50,000 g/mol and in particular 30,000 to 40,000 g/mol.

The (co)polymeric polycarboxylates may be used either as a powder or as an aqueous solution. The content of (co)polymeric polycarboxylates in the washing or cleaning agents preferably amounts to 0.5 to 20 wt. % and in particular to 3 to 10 wt. %.

In order to improve water solubility, the polymers may also contain allylsulfonic acids such as allyloxybenzenesulfonic acid and methallylsulfonic acid as a monomer.

In particular, biodegradable polymers prepared from more than two different monomer units are preferred, for example, those containing salts of acrylic acid and of maleic acid and vinyl alcohol or vinyl alcohol derivatives as monomers or which contain salts of acrylic acid and of 2-alkylallylsulfonic acid and sugar derivatives as monomers.

Further preferred copolymers comprise acrolein and acrylic acid/acrylic acid salt or acrolein and vinyl acetate as monomers.

Polymers with a water-softening action include polymers containing sulfonic acid groups, which are particularly preferentially used. Corresponding polymers have already been described above as components of bleach activator granules according to the invention, to which reference is made in order to avoid repetition.

Polymeric aminodicarboxylic acids, the salts or precursor substances thereof may likewise be mentioned as further preferred builder substances. Polyaspartic acid or the salts thereof are particularly preferred.

Further suitable builder substances are polyacetals which may be obtained by reacting dialdehydes with polyolcarboxylic acids which comprise 5 to 7 C atoms and at least 3 hydroxyl groups. Preferred polyacetals are obtained from dialdehydes such as glyoxal, glutaraldehyde, terephthalaldehyde as well as mixtures thereof and from polyolcarboxylic acids such as gluconic acid and/or glucoheptonic acid.

Oxydisuccinates and other derivatives of disuccinates, preferably ethylenediamine disuccinate, are also further suitable cobuilders. Ethylenediamine-N,N′-disuccinate (EDDS) is preferably used in the form of the sodium or magnesium salts thereof. Glycerol disuccinates and glycerol trisuccinates are also preferred in this connection. Suitable amounts used are 3 to 15 wt. %.

In addition to 1-hydroxyethane-1,1-diphosphonic acid, complexing phosphonates include a series of different compounds such as diethylenetriaminepenta(methylenephosphonic acid) (DTPMP). Hydroxyalkane- or aminoalkanephosphonates, in particular, are preferred. Among hydroxyalkanephosphonates, 1-hydroxyethane-1,1-diphosphonate (HEDP) is of particular significance as a cobuilder. It is preferably used as a sodium salt, with the disodium salt exhibiting a neutral reaction and the tetrasodium salt an alkaline (pH 9) reaction. Useful aminoalkanephosphonates include ethylenediaminetetramethylenephosphonate (EDTMP), diethylenetriaminepentamethylenephosphonate (DTPMP), as well as the higher homologs thereof. They are preferably used in the form of the sodium salts which exhibit a neutral reaction, for example, as the hexasodium salt of EDTMP or as the hepta- and octasodium salt of DTPMP. Among the phosphonates, HEDP is preferably used as a builder. Aminoalkanephosphonates furthermore exhibit a pronounced heavy metal binding capacity. It may accordingly be preferred, especially if the agents also contain bleach, to use aminoalkanephosphonates, in particular DTPMP, or mixtures of the stated phosphonates.

Preferred automatic dishwashing agents contain one or more phosphonate(s) from the group—
a) aminotrimethylenephosphonic acid (ATMP) and/or the salts thereof;
b) ethylenediaminetetra(methylenephosphonic acid) (EDTMP) and/or the salts thereof;
c) diethylenetriaminepenta(methylenephosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) hexamethylenediaminetetra(methylenephosphonic acid) (HDTMP) and/or the salts thereof;
g) nitrilotri(methylenephosphonic acid) (NTMP) and/or the salts thereof.

Particularly preferred automatic dishwashing agents contain 1-hydroxyethane-1,1-diphosphonic acid (HEDP) or diethylenetriaminepenta(methylenephosphonic acid) (DTPMP) as the phosphonate.

Automatic dishwashing agents according to the invention can also contain two or more different phosphonates.

Bi- or multiphase washing or cleaning agents wherein the bi- or multiphasic washing or cleaning agent contains at least one phosphonate, preferably 1-hydroxyethane-1,1-diphosphonic acid (HEDP), which is present together with bleaching agent a) in one phase of the washing or cleaning agent are preferred according to the invention.

The amount of phosphonates is preferably 0.5 to 14 wt. %, preferably 1 to 12 wt. % and in particular 2 to 8 wt. %.

Example formulations of preferred bi- or multiphase washing or cleaning agents containing phosphonate are illustrated in the following tables—

| | Formula- | Formula- | Formula- | Formula- |
|---|---|---|---|---|
| | tion 77 | tion 78 | tion 79 | tion 80 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Phosphonate [1] | 0.5 to 14 | 1 to 12 | 1 to 12 | 2 to 8 |
| | Formula- | Formula- | Formula- | Formula- |
| | tion 81 | tion 82 | tion 83 | tion 84 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Phosphonate [1] | 0.5 to 14 | 1 to 12 | 1 to 12 | 2 to 8 |
| | Formula- | Formula- | Formula- | Formula- |
| | tion 85 | tion 86 | tion 87 | tion 88 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Phosphonate [1] | 0.5 to 14 | 1 to 12 | 1 to 12 | 2 to 8 |

Automatic dishwashing agents according to the invention can contain methylglycinediacetic acid or a salt of thereof, wherein the amount of methylglycinediacetic acid or its salt is preferably from 0.5 to 15 wt. %, preferably 0.5 to 10 wt. % and particularly 0.5 to 6 wt. %.

Further usable organic cobuilders include acetylated hydroxycarboxylic acids or the salts thereof, which can optionally also be present in lactone form and contain at least 4 carbon atoms and at least one hydroxyl group and at most two acid groups.

Any compounds capable of forming complexes with alkaline earth ions can be used as builders.

Surfactants include nonionic, anionic, cationic and amphoteric surfactants.

Those nonionic surfactants known to a person skilled in the art can be used. Suitable nonionic surfactants include alkyl glycosides of the general formula RO(G)ₓ, wherein R corresponds to a primary straight-chain or methyl-branched aliphatic residue, in particular methyl-branched in position 2, with 8 to 22, preferably 12 to 18 C atoms and G is a glycose unit with 5 or 6 C atoms, preferably glucose. The degree of oligomerization x, which indicates the distribution of monoglycosides and oligoglycosides, is a number from 1 to 10, preferably 1.2 to 1.4.

Another class of preferred nonionic surfactants, which can be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants can be used as preferred surfactants. Washing or cleaning agents, in particular cleaning agents for automatic dishwashing, particularly preferentially contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. The preferred ethoxylated alcohols include for example C₁₂₋₁₄ alcohols with 3 EO to 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO 25 EO, 30 EO or 40 EO.

Ethoxylated nonionic surfactants which were obtained from C₆₋₂₀ monohydroxyalkanols or C₆₋₂₀ alkylphenols or C₁₆₋₂₀ fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₈ alcohol, and at least 12 mol, preferably at least 15 mol and in particular at least 20 mol of ethylene oxide. Among these, “narrow range ethoxylates” are particularly preferred.

Combinations of one or more tallow fatty alcohols with 20 to 30 EO and silicone defoamers are particularly preferentially used.

In particular, nonionic surfactants having a melting point of above room temperature are preferred. Nonionic surfactant(s) with a melting point of above 20° C., preferably of above 25° C., particularly preferably of between 25 and 60° C. and in particular of between 26.6 and 43.3° C., is/are particularly preferred.

Preferably used surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further preferred nonionic surfactants having a melting point above room temperature contain 40 to 70% of a polyoxypropylene/polyoxyethylene/polyoxypropylene block polymer blend, containing 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Particularly preferred nonionic surfactants are low-foaming nonionic surfactants having alternating ethylene oxide and alkylene oxide units. Among these, surfactants with EO-AO-EO-AO blocks are in turn preferred, with one to ten EO or AO groups being attached to one another before being followed by a block of the respective other groups. Preferred nonionic surfactants include those of the general formula—

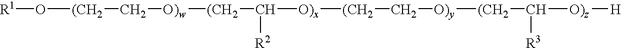

wherein R¹ is a straight-chain or branched, saturated or mono- or polyunsaturated C₆₋₂₄ alkyl or alkenyl residue; R² and R³ are mutually and independently —CH₃, —CH₂CH₃, —CH₂CH₂—CH₃, or CH(CH₃)₂, and the indices w, x, y, z mutually and independently are integers from 1 to 6.

Nonionic surfactants are preferably those having a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of general formula R¹—CH(OH)CH₂O-(AO)_{w}-(A′O)ₓ-(A″O)_{y}-(A′″O)_{z}—R², wherein R¹ and R² are mutually and independently a straight-chain or branched, saturated or mono- or polyunsaturated C₂₋₄₀ alkyl or alkenyl residue; A, A′, A″ and A′″ are mutually and independently —CH₂CH₂, —CH₂CH₂—CH₂, —CH₂—CH(CH₃), —CH₂—CH₂—CH₂—CH₂, —CH₂—CH(CH₃)—CH₂—, or —CH₂—CH(CH₂—CH₃); and w, x, y and z are values from 0.5 to 90, with x, y and/or z possibly also being 0, are preferred according to the invention.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants include those of the formula R¹O[CH₂CH(CH₃)O]ₓ[CH₂CH₂O]_{y}CH₂CH(OH)R², wherein R¹ is a linear or branched aliphatic hydrocarbon residue with 4 to 18 carbon atoms or mixtures thereof, R² is a linear or branched hydrocarbon residue with 2 to 26 carbon atoms or mixtures thereof, x is a value from 0.5 to 1.5, and y is a value of at least 15.

Particularly preferred end group-terminated poly(oxyalkylated) nonionic surfactants further include those of the formula R¹O[CH₂CH₂O]ₓ[CH₂CH(R³)O]_{y}CH₂CH(OH)R², wherein R¹ and R² are mutually and independently linear or branched, saturated or mono- or polyunsaturated hydrocarbon residue with 2 to 26 carbon atoms, R³ is mutually independently —CH₃, —CH₂CH₃, —CH₂CH₂—CH₃, or —CH(CH₃)₂, but is preferably —CH₃, and x and y mutually independently are values from 1 to 32, with nonionic surfactants with R³═—CH₃ and values of x from 15 to 32 and y from 0.5 to 1.5 being very particularly preferred.

Further preferred nonionic surfactants include end group-terminated poly(oxyalkylated) nonionic surfactants of the formula R¹O[CH₂CH(R³)O]ₓ[CH₂]ₖCH(OH)[CH₂]ⱼOR², wherein R¹ and R² are mutually and independently linear or branched, saturated or unsaturated, aliphatic or aromatic hydrocarbon residues with 1 to 30 carbon atoms, R³ is H or a methyl, ethyl, n-propyl, iso-propyl, n-butyl, 2-butyl or 2-methyl-2-butyl residue, x is a value from 1 to 30, k and j are values from 1 to 12, preferably from 1 to 5. If the value of x is ≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH₃ or —CH₂CH₃ are particularly preferred for R³. Particularly preferred values for x are in the range from 1 to 20, in particular 6 to 15.

As described above, each R³ in the above formula can be different if x is ≧2. In this manner, it is possible to vary the alkylene oxide unit in the square brackets. If x is 3, for example, R³ can be chosen so that ethylene oxide (R³═H) or propylene oxide (R³═CH₃) units are formed, which may be attached to one another in any sequence (e.g., (EO)(PO)(EO), (EO)(EO)(PO), (EO)(EO)(EO), (PO)(EO)(PO), (PO)(PO)(EO) and (PO)(PO)(PO)). The value 3 for x has been selected here by way of example and may perfectly well be larger, the range of variation increasing as the value of x rises and, for example, comprising a large number of (EO) groups combined with a small number of (PO) groups, or vice versa.

Particularly preferred end group-terminated poly(oxyalkylated) alcohols of the above-stated formula have values of k=1 and j=1, simplifying the formula to R¹O[CH₂CH(R³)O]ₓCH₂CH(OH)CH₂OR². In this formula, R¹, R² and R³ are as defined above and x is a number from 1 to 30, preferably from 1 to 20 and in particular from 6 to 18. Particularly preferred surfactants are those in which the residues R¹ and R² have 9 to 14 C atoms, R³ is H and x assumes values from 6 to 15.

The stated C chain lengths and degrees of ethoxylation or degrees of alkoxylation of the above-stated nonionic surfactants are statistical averages which, for a specific product, can be an integer or a fractional number. Due to production methods, commercial products of the stated formulae do not in the main consist of an individual representative, but instead of mixtures, whereby not only C chain lengths but also the degrees of ethoxylation or degrees of alkoxylation may be averages and consequently fractional numbers.

The above-stated nonionic surfactants can be used not only as individual ingredients, but also as surfactant mixtures of two, three, four or more surfactants. Surfactant mixtures do not include nonionic surfactants mixtures which fall within one of the above-stated general formulae, but rather mixtures having two, three, four or more nonionic surfactants described by any of the above-stated general formulae.

If anionic surfactants are used as a component of automatic dishwashing agents, the content thereof, based on total weight of the agents, is preferably less than 4 wt. %, more preferably less than 2 wt. % and very particularly preferably less than 1 wt. %. Automatic dishwashing agents containing no anionic surfactants are particularly preferred.

Cationic and/or amphoteric surfactants can be used instead of or in conjunction with the stated surfactants.

In automatic dishwashing agents, the amount of cationic and/or amphoteric surfactants is preferably less than 6 wt. %, more preferably less than 4 wt. %, very particularly preferably less than 2 wt. % and in particular less than 1 wt. %. Automatic dishwashing agents containing no cationic or amphoteric surfactants are particularly preferred.

Example formulations of preferred bi- or multiphase washing or cleaning agents containing surfactants are illustrated in the following tables—

| | Formula- | Formula- | Formula- | Formula- |
|---|---|---|---|---|
| | tion 89 | tion 90 | tion 91 | tion 92 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Nonionic surfactant* | 0.1 to 15 | 0.2 to 10 | 0.5 to 8 | 1 to 6 |
| | Formula- | Formula- | Formula- | Formula- |
| | tion 93 | tion 94 | tion 95 | tion 96 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Nonionic surfactant* | 0.1 to 15 | 0.2 to 10 | 0.5 to 8 | 1 to 6 |
| | Formula- | Formula- | Formula- | Formula- |
| | tion 97 | tion 98 | tion 99 | tion 100 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Nonionic surfactant* | 0.1 to 15 | 0.2 to 10 | 0.5 to 8 | 1 to 6 |

Polymer ingredients include polymers with a washing or cleaning action, for example, rinsing polymers and/or polymers with a water-softening action. In general, in addition to nonionic polymers, it is also possible to use cationic, anionic and amphoteric polymers in washing or cleaning agents.

“Cationic polymers” refers to polymers having a positive charge in the polymer molecule. This can be achieved by (alkyl)ammonium groupings or other positively charged groups present in the polymer chain. Particularly preferred cationic polymers originate from quaternized cellulose derivatives, polysiloxanes with quaternary groups, cationic guar derivatives, polymeric dimethyldiallylammonium salts and the copolymers thereof with esters and amides of acrylic acid and methacrylic acid, copolymers of vinylpyrrolidone with quaternized derivatives of dialkylamino acrylate and methacrylate, vinylpyrrolidone-methoimidazolinium chloride copolymers, quaternized polyvinyl alcohols or the polymers known by the INCI names Polyquaternium 2, Polyquaternium 17, Polyquaternium 18 and Polyquaternium 27.

In addition to a positively charged group in the polymer chain, “amphoteric polymers” also comprise negatively charged groups or monomer units. These groups can include carboxylic acids, sulfonic acids or phosphonic acids.

Preferred washing or cleaning agents can contain a polymer a) having monomer units of the formula R¹R²C═CR³R⁴, wherein R¹, R², R³, and R⁴ are mutually and independently hydrogen, derivatized hydroxy group, C₁₋₃₀ linear or branched alkyl groups, aryl, C₁₋₃₀ linear or branched alkyl groups substituted with aryl, polyalkoxylated alkyl groups, heteroatomic organic groups with at least one positive charge without charged nitrogen, at least one quaternized N atom or at least one amino group with a positive charge in the subrange of the pH range of 2 to 11, or salts thereof, with the proviso that at least one residue R¹, R², R³, and R⁴ is a heteroatomic organic group with at least one positive charge without charged nitrogen, at least one quaternized N atom or at least one amino group with a positive charge.

Cationic or amphoteric polymers which are particularly preferred for the purposes of the present application contain as monomer unit a compound of the general formula—

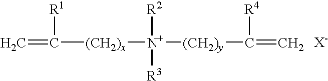

wherein R¹ and R⁴ are mutually and independently H or a linear or branched hydrocarbon residue with 1 to 6 carbon atoms; R² and R³ are mutually and independently an alkyl, hydroxyalkyl or aminoalkyl group in which the alkyl residue is linear or branched and comprises from 1 to 6 carbon atoms, preferably a methyl group; x and y are mutually and independently integers from 1 to 3. X⁻ is a counterion, preferably chloride, bromide, iodide, sulfate, hydrogensulfate, methosulfate, laurylsul fate, dodecylbenzenesulfonate, p-toluenesulfonate (tosylate), cumenesulfonate, xylenesulfonate, phosphate, citrate, formate, acetate or mixtures thereof.

R¹ and R⁴ in the above formula are preferably —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, or —(CH₂CH₂—O)ₙH.

Very particularly preferred polymers comprise a cationic monomer unit of the above general formula, wherein R¹ and R⁴ are H, R² and R³ are methyl, and x and y are 1. The corresponding monomer unit of the formula—

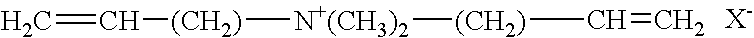

is also known as DADMAC (diallyldimethylammonium chloride) when X⁻ is chloride.

Further particularly preferred cationic or amphoteric polymers contain a monomer unit of the general formula—

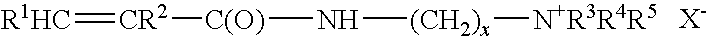

wherein R¹, R², R³, R⁴ and R⁵ are mutually and independently a linear or branched, saturated or unsaturated alkyl or hydroxyalkyl residue with 1 to 6 carbon atoms, preferably a linear or branched alkyl residue chosen from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH and x denotes an integer from 1 to 6.

Particular preferred polymers comprise a cationic monomer unit of the above general formula, wherein R¹ is H, R², R³, R⁴ and R⁵ are methyl, and x is 3. The corresponding monomer units of the formula—

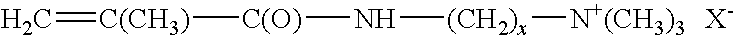

are also known as MAPTAC (methyacrylamidopropyltrimethylammonium chloride) when X⁻ is chloride.

Polymers containing diallyldimethylammonium salts and/or acrylamidopropyltrimethylammonium salts as monomer units are preferably used.

The previously mentioned amphoteric polymers can contain not only cationic groups, but also anionic groups or monomer units. Such anionic monomer units can originate from linear or branched, saturated or unsaturated carboxylates, linear or branched, saturated or unsaturated phosphonates, linear or branched, saturated or unsaturated sulfates or linear or branched, saturated or unsaturated sulfonates. Preferred monomer units include acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid and the derivatives thereof, allylsulfonic acids, such as for example allyloxybenzenesulfonic acid and methallylsulfonic acid or allylphosphonic acids.

Preferably usable amphoteric polymers originate from the group of alkylacrylamide/acrylic acid copolymers, alkylacrylamide/methacrylic acid copolymers, alkylacrylamide/methyl methacrylic acid copolymers, alkylacrylamide/acrylic acid/alkylaminoalkyl (meth)acrylic acid copolymers, alkylacrylamide/methacrylic acid/alkylaminoalkyl (meth)acrylic acid copolymers, alkylacrylamide/methyl methacrylic acid/alkylaminoalkyl (meth)acrylic acid copolymers, alkylacrylamide/alkyl methacrylate/alkylaminoethyl methacrylate/alkyl methacrylate copolymers and copolymers of unsaturated carboxylic acids, cationically derivatized unsaturated carboxylic acids and optionally further ionic or nonionogenic monomers.

Preferably usable zwitterionic polymers originate from the group of acrylamidoalkyltrialkylammonium chloride/acrylic acid copolymers and the alkali metal and ammonium salts thereof, acrylamidoalkyltrialkylammonium chloride/methacrylic acid copolymers and the alkali metal and ammonium salts thereof and methacroylethylbetaine/methacrylate copolymers.

Amphoteric polymers which, in addition to one or more anionic monomers, comprise methacrylamidoalkyltrialkylammonium chloride and dimethyl(diallyl)ammonium chloride as cationic monomers are furthermore preferred.

Particularly preferred amphoteric polymers originate from the group of methacrylamidoalkyltrialkylammonium chloride/dimethyl(diallyl)ammonium chloride/acrylic acid copolymers, methacrylamidoalkyltrialkylammonium chloride/dimethyl(diallyl)ammonium chloride/methacrylic acid copolymers and methacrylamidoalkyltrialkylammonium chloride/dimethyl(diallyl)ammonium chloride/alkyl(meth)acrylic acid copolymers and the alkali metal and ammonium salts thereof.

Particularly preferred amphoteric polymers are those from the group of methacrylamidopropyltrimethylammonium chloride/dimethyl(diallyl)ammonium chloride/acrylic acid copolymers, methacrylamidopropyltrimethylammonium chloride/dimethyl(diallyl)ammonium chloride/acrylic acid copolymers and methacrylamidopropyltrimethylammonium chloride/dimethyl(diallyl)ammonium chloride/alkyl(meth)acrylic acid copolymers and the alkali metal and ammonium salts thereof.

Washing or cleaning agents preferably contain the above-stated cationic and/or amphoteric polymers in quantities of from 0.01 to 10 wt. %, based on total weight of the washing or cleaning agent. Washing or cleaning agents which are preferred for the purposes of the present application are, however, those in which the amount of cationic and/or amphoteric polymers is from 0.01 to 8 wt. %, preferably from 0.01 to 6 wt. %, preferably from 0.01 to 4 wt. %, particularly preferably from 0.01 to 2 wt. % and in particular from 0.01 to 1 wt. %, based on total weight of the automatic dishwashing agent.

Enzymes can be included in the agent to increase the washing or cleaning performance of washing or cleaning agents. These include in particular proteases, amylases, lipases, hemicellulases, cellulases, perhydrolases or oxidoreductases, preferably together with mixtures thereof. These enzymes are in principle of natural origin; starting from the natural molecules, improved variants are available for use in washing or cleaning agents, said variants accordingly preferably being used. Washing or cleaning agents preferably contain enzymes in total quantities of 1×10⁻⁶ to 5 wt. % relative to active protein. Protein concentration can be determined using known methods such as the BCA method or the biuret method.

Among proteases, those of the subtilisin type are preferred. Examples of these are subtilisins BPN′ and Carlsberg and their further developed forms protease PB92, subtilisins 147 and 309, alkaline protease from Bacillus lentus, subtilisin DY and the enzymes thermitase, proteinase K and proteases TW3 and TW7, which are classed among subtilases but no longer among the subtilisins as more narrowly defined.

Examples of amylases usable according to the invention are the α-amylases from Bacillus licheniformis, from B. amyloliquefaciens, from B. stearothermophilus, from Aspergillus niger and A. oryzae and the further developed forms of the above-stated amylases which have been improved for use in washing and cleaning agents. Particular note should furthermore be taken for this purpose of the α-amylase from Bacillus sp. A 7-7 (DSM 12368) and the cyclodextrin glucanotransferase (CGTase) from B. agaradherens (DSM 9948).

One or more enzymes and/or enzyme preparations, preferably solid protease preparations and/or amylase preparations, are preferably used in quantities of 0.1 to 5 wt. %, preferably of 0.2 to 4.5 wt. % and in particular of 0.4 to 4 wt. %, in each case relative to the total enzyme-containing agent.

Example formulations of preferred bi- or multiphase washing or cleaning agents containing enzymes are illustrated in the following tables—

| | Formula- | Formula- | Formula- | Formula- |
|---|---|---|---|---|
| | tion 101 | tion 102 | tion 103 | tion 104 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Enzyme preparation [2] | 0.1 to 12 | 0.2 to 10 | 0.5 to 8 | 0.5 to 8 |
| | Formula- | Formula- | Formula- | Formula- |
| | tion 105 | tion 106 | tion 107 | tion 108 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Enzyme preparation [2] | 0.1 to 12 | 0.2 to 10 | 0.5 to 8 | 0.5 to 8 |
| | Formula- | Formula- | Formula- | Formula- |
| | tion 109 | tion 110 | tion 111 | tion 112 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Enzyme preparation [2] | 0.1 to 12 | 0.2 to 10 | 0.5 to 8 | 0.5 to 8 |

Glass corrosion inhibitors prevent the occurrence not only of hazing, streaking and scratching but also of iridescence on the surface of machine washed glasses. Preferred glass corrosion inhibitors originate from the group of magnesium and zinc salts and of magnesium and zinc complexes.

The spectrum of zinc salts preferred according to the invention, preferably of organic acids, particularly preferably of organic carboxylic acids, extends from salts which are sparingly soluble or insoluble in water (i.e., exhibit a solubility of below 100 mg/l, preferably below 10 mg/l, in particular below 0.01 mg/l) up to those salts having a solubility in water of 100 mg/l or greater, preferably 500 mg/l or greater, particularly preferably 1 g/l or greater, and particularly 5 g/l or greater (solubility at 20° C. water temperature). Sparingly soluble zinc salts include zinc citrate, zinc oleate and zinc stearate, while the group of soluble zinc salts include zinc formate, zinc acetate, zinc lactate and zinc gluconate.

At least one zinc salt of an organic carboxylic acid, particularly preferably a zinc salt from the group of zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

For the purposes of the present invention, the amount of zinc salt in washing or cleaning agents is preferably from 0.1 to 5 wt. %, preferably 0.2 to 4 wt. % and particularly 0.4 to 3 wt. %, or the content of oxidized zinc (calculated as Zn²⁺) is from 0.01 to 1 wt. %, preferably 0.02 to 0.5 wt. % and particularly 0.04 to 0.2 wt. %, based on total weight of the preparation containing the glass corrosion inhibitor.

Corrosion inhibitors serve to protect items being washed or the machine, silver protection agents being of particular significance in relation to automatic dishwashing. Known prior art substances can be used. In general, silver protection agents that can be used are those primarily chosen from triazoles, benzotriazoles, bisbenzotriazoles, aminotriazoles, alkylaminotriazoles and transition metal salts or complexes. Benzotriazole and/or alkylaminotriazole are particularly preferably used.

Detergent formulations further often comprise agents containing active chlorine capable of distinctly reducing corrosion of silver surfaces. Organic redox-active compounds containing oxygen and nitrogen, such as di- and trihydric phenols, for example hydroquinone, pyrocatechol, hydroxyhydroquinone, gallic acid, phloroglucinol, pyrogallol or derivatives of these classes of compounds are in particular used in chlorine-free cleaning products. Saline and complexed inorganic compounds, such as salts of metals Mn, Ti, Zr, Hf, V, Co and Ce are also frequently used. Preferred compounds are here transition metal salts, which are selected from the group of manganese and/or cobalt salts and/or complexes, particularly preferably the cobalt (ammine) complexes, cobalt (acetate) complexes, cobalt (carbonyl) complexes, the chlorides of cobalt or manganese and of manganese sulfate. Zinc compounds may likewise by used to prevent corrosion of the articles being washed.

The stated metal salts and/or metal complexes are present in the cleaning agents according to the invention preferably in a quantity of from 0.05 to 6 wt. %, preferably 0.2 to 2.5 wt. %, relative to the total agent.

Bi- or multiphase washing or cleaning agents containing a silver protection agent present together with bleaching agent a) in one phase of the washing or cleaning agent, are preferred according to the invention.

Example formulations of preferred bi- or multiphase washing or cleaning agents containing silver protection agents are illustrated in the following tables—

| | Formula- | Formula- | Formula- | Formula- |
|---|---|---|---|---|
| | tion 113 | tion 114 | tion 115 | tion 116 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Silver protection | 0.05 to 6 | 0.05 to 6 | 0.2 to 2.5 | 0.2 to 2.5 |
| agent [1] | | | | |
| | Formula- | Formula- | Formula- | Formula- |
| | tion 117 | tion 118 | tion 119 | tion 120 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Silver protection | 0.05 to 6 | 0.05 to 6 | 0.2 to 2.5 | 0.2 to 2.5 |
| agent [1] | | | | |
| | Formula- | Formula- | Formula- | Formula- |
| | tion 121 | tion 122 | tion 123 | tion 124 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Silver protection | 0.05 to 6 | 0.05 to 6 | 0.2 to 2.5 | 0.2 to 2.5 |
| agent [1] | | | | |

Perfume oils or scents can be used for the purposes of the present invention and include individual fragrance compounds such as synthetic products of the ester, ether, aldehyde, ketone, alcohol, and hydrocarbon type. Preferably, however, mixtures of various fragrances are used which together produce an attractive scent note. Such perfume oils can also contain natural fragrance mixtures obtained from plant sources (e.g., pine, citrus, jasmine, patchouli, rose or ylang-ylang oil).

Preferred dyes, the selection of which will cause the person skilled in the art no difficulty, have elevated storage stability and are insensitive to the other ingredients of the preparations and to light and have no marked substantivity relative to the substrates such as for example textiles, glass, ceramics or plastic crockery to be treated with the dye-containing preparations so as not to dye these substrates.

Disintegration of prefabricated moldings may be facilitated by incorporating disintegration auxiliaries or “tablet disintegrants” into these agents in order to shorten disintegration times. Tablet disintegrants or disintegration accelerators are taken to mean auxiliary substances which ensure the rapid disintegration of tablets in water or other media and the prompt release of the active ingredients.

These substances, known as disintegrants due to their mode of action, increase in volume on exposure to water, resulting, on the one hand, in an increase of their own volume (swelling) and, on the other hand, possibly also in generation of pressure due to the release of gases, causing the tablet to break up into smaller particles. Disintegration auxiliaries which have long been known are for example carbonate/citric acid systems, it also being possible to use other organic acids. Swelling disintegration auxiliaries include synthetic polymers such as polyvinylpyrrolidone (PVP) or natural polymers or modified natural materials such as cellulose and starch and the derivatives thereof, alginates or casein derivatives.

Disintegration auxiliaries are preferably used in quantities of 0.5 to 10 wt. %, preferably 3 to 7 wt. % and in particular 4 to 6 wt. %, based on total weight of the agent containing the disintegration auxiliary.

Preferred disintegration auxiliaries, preferably a cellulose-based disintegration auxiliary, preferably in granular, cogranulated or compacted form, are present in the preparation containing the disintegration agent in quantities of 0.5 to 10 wt. %, preferably 3 to 7 wt. % and in particular 4 to 6 wt. %, based on total weight of the preparation containing the disintegration agent.

Gas-evolving effervescent systems may furthermore preferably be used according to the invention as tablet disintegration auxiliaries. The gas-evolving effervescent system may consist of a single substance which releases a gas on contact with water. Magnesium peroxide, which releases oxygen on contact with water, may in particular be mentioned among these compounds. Conventionally, however, the gas-releasing effervescent system in turn consists of at least two components which react with one another to form gas. While numerous systems which for example release nitrogen, oxygen or hydrogen may be imagined and implemented, the effervescent system used in the washing and cleaning agents will be selected in the light of both economic and environmental considerations. Preferred effervescent systems consist of alkali metal carbonate and/or hydrogencarbonate and an acidifying agent suitable for releasing carbon dioxide from the alkali metal salts in aqueous solution.

Usable acidifying agents which release carbon dioxide from the alkali metal salts in aqueous solution include boric acid and alkali metal hydrogensulfates, alkali metal dihydrogenphosphates and other inorganic salts. Organic acidifying agents, however, are preferably used, citric acid being a particularly preferred acidifying agent. Preferred acidifying agents in the effervescent system are from the group of organic di-, tri- and oligocarboxylic acids or mixtures.

Washing or cleaning agents according to the invention are present as bi- or multiphase presentations, preferably in the form of bi-, tri- or tetraphasic presentations.

These presentations are themselves preferably formulated in the form of a dispensing unit. In the present application, the phrase “washing or cleaning agent dispensing unit” here in particular denotes those presentations which contain a sufficient quantity of substances with a washing and cleaning action to carry out individual cleaning cycles. Such presentations preferably have, for example, a weight of between 8 and 35 g, preferably of between 10 and 30 g and in particular of between 12 and 25 g. The volume of the moldings is here conventionally in the range between 5 and 40 ml, preferably between 8 and 30 ml and in particular between 12 and 20 ml.

Particularly preferred washing or cleaning agent dispensing units have dimensions of the order of 5 cm×3 cm×3 cm, preferably of the order of 4.5 cm×2.5 cm×2.5 cm, particularly preferably of the order of 4 cm×2 cm×2 cm.

In the context of the present application, a “phase” of these bi- or multiphase washing or cleaning agent dispensing units refers to macroscopically visible regions of these dispensing units. For tableted washing or cleaning agent dispensing units, these can comprise layers or cores. Regarding dispensing units in the form of injection moldings or film pouches, preparations with a washing or cleaning action which separate from one another in compartments of these dispensing units are described as “phases”.

Bi- or multiphase washing or cleaning agents according to the invention can be in the form of solid or liquid phases or combinations of solid and liquid phases.

Examples of the above-described bi- or multiphase washing or cleaning agent dispensing units are, as previously explained, bi- or multilayer tablets, injection moldings with two or more compartments which are separate from one another or film pouches with two or more compartments which are separate from one another.

In a particularly preferred embodiment, bi- or multiphase washing or cleaning agents according to the invention are in the form of bi- or multiphase, preferably bi- or multilayer tablets.

Individual phases of the bi- or multiphase base tablet or core tablet are preferably arranged in layers. The amount of the smallest phase is preferably at least 5 wt. %, more preferably at least 10 wt. % and in particular at least 20 wt. %, based on total weight of the total tablet. The amount of the phase with the greatest proportion by weight in the tablet is preferably in biphasic tablets no more than 90 wt. %, preferably no more than 80 wt. % and in particular from 55 to 70 wt. %. In triphasic tablets, the amount of the phase with the greatest proportion by weight in the tablet is preferably no more than 80 wt. %, preferably no more than 70 wt. % and in particular from 35 to 60 wt. %.

The dishwashing agent tablets are preferably produced in a manner known to a person skilled in the art by press-molding particulate premixes. It is here preferred according to the invention for the particulate premix to exhibit an average particle size of from 0.4 to 3.0 mm, preferably 0.6 to 2.5 mm and in particular 0.8 to 2.0 mm.

Methods which are preferred for the purposes of the present invention are characterized in that press-molding proceeds at molding pressures of 0.01 to 50 kNcm⁻², preferably of 0.1 to 40 kNcm⁻² and in particular of 1 to 25 kNcm⁻².

Density of preferred dishwashing agent tablets according to the invention is from 1.1 to 1.8 g/cm³, preferably from 1.2 to 1.7 g/cm³, and particularly from 1.3 to 1.6 g/cm³.

The present application also provides a method of producing a bi- or multiphase washing or cleaning agent tablet, wherein a particulate premix comprising—
a) a bleaching agent,
b) a bleach activator, and
c) a bleach catalyst chosen from bleach-boosting transition metal salts and transition metal complexes,
   is produced and press-molded to form a tablet so that bleaching agent a) is present together with at least one of components b) and c) in one phase of the washing or cleaning agent Example formulations of preferred bi- or multiphase washing or cleaning agent tablets may be found in the following tables—

| | Formula- | Formula- | Formula- | Formula- |
|---|---|---|---|---|
| | tion 125 | tion 126 | tion 127 | tion 128 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Builder* | 1 to 60 | 2 to 50 | 5 to 50 | 10 to 50 |
| Polymer containing acid | 0.1 to 30 | 0.5 to 25 | 1 to 20 | 1 to 20 |
| groups* | | | | |
| Nonionic surfactant* | 0.1 to 15 | 0.2 to 10 | 0.5 to 8 | 1 to 6 |
| Enzyme preparation [2] | 0.1 to 12 | 0.2 to 10 | 0.5 to 8 | 0.5 to 8 |

*component of phases [1] and/or [2] and/or of one or more further phases

| | Formula- | Formula- | Formula- | Formula- |
|---|---|---|---|---|
| | tion 129 | tion 130 | tion 131 | tion 132 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [1] | 0.1 to 10 | 0.5 to 8 | 0.5 to 8 | 1 to 6 |
| Bleach catalyst [2] | 0.001 to 3 | 0.001 to 3 | 0.01 to 2 | 0.01 to 1.0 |
| Builder* | 1 to 60 | 2 to 50 | 5 to 50 | 10 to 50 |
| Polymer containing acid | 0.1 to 30 | 0.5 to 25 | 1 to 20 | 1 to 20 |
| groups* | | | | |
| Nonionic surfactant* | 0.1 to 15 | 0.2 to 10 | 0.5 to 8 | 1 to 6 |
| Enzyme preparation [2] | 0.1 to 12 | 0.2 to 10 | 0.5 to 8 | 0.5 to 8 |

*component of phases [1] and/or [2] and/or of one or more further phases

| | Formula- | Formula- | Formula- | Formula- |
|---|---|---|---|---|
| | tion 133 | tion 134 | tion 135 | tion 136 |
| Ingredient [phase] | [wt. %] | [wt. %] | [wt. %] | [wt. %] |
| Oxygen bleaching | 2 to 30 | 4 to 20 | 4 to 20 | 6 to 15 |
| agent [1] | | | | |
| Bleach activator [2] | 0.1 to 10 | 0.5 to 8 | 0.5 to 8 | 1 to 6 |
| Bleach catalyst [1] | 0.001 to 3 | 0.001 to 3 | 0.01 to 2 | 0.01 to 1.0 |
| Builder* | 1 to 60 | 2 to 50 | 5 to 50 | 10 to 50 |
| Polymer containing acid | 0.1 to 30 | 0.5 to 25 | 1 to 20 | 1 to 20 |
| groups* | | | | |
| Nonionic surfactant* | 0.1 to 15 | 0.2 to 10 | 0.5 to 8 | 1 to 6 |
| Enzyme preparation [2] | 0.1 to 12 | 0.2 to 10 | 0.5 to 8 | 0.5 to 8 |

*component of phases [1] and/or [2] and/or of one or more further phases

In order to increase throughput, rotary presses may also be provided with two feed shoes, as a result of which it is then only necessary to execute a half rotation to produce a tablet.

As initially mentioned, for the purposes of the present invention, the tablets may likewise be of multiphasic, in particular multilayer, structure. The moldings may here be manufactured in a predetermined three-dimensional shape and predetermined size. Three-dimensional shapes which may be considered include virtually any developments which can sensibly be handled, thus for example slabs, rods or bars, cubes, cuboids and corresponding three-dimensional elements with planar side faces and in particular cylindrical developments with a circular or oval cross-section. This final development here includes presentations ranging from a tablet up to compact cylindrical pieces with a ratio of height to diameter of above 1.

Bi- and multilayer moldings are produced by arranging two or more feed shoes in succession, without the gently pressed first layer being ejected before further filling. In this manner, it is possible by suitable process control also to produce jacketed and bull's eye tablets, which have an onion skin type structure, in which in the case of bull's eye tablets the upper side of the core or of the core layers is not covered and thus remains visible. Recessed tablets which comprise a recess (a cavity open on one side defined by webs and a base area) on their upper side may furthermore also be produced.

Particularly preferred bi- or multiphase washing or cleaning agents according to the invention have the form of a recessed tablet with a core inserted, preferably pressed, into the recess.

Corresponding preferred methods for producing a dishwashing agent tablet include producing a particulate premix comprising—
a) a bleaching agent,
b) a bleach activator, and
c) a bleach catalyst chosen from bleach-boosting transition metal salts and transition metal complexes,
   and press-molding the premix to form a recessed tablet so that bleaching agent a) is present together with at least one of components b) and c) in one phase of the washing or cleaning agent.

After press-molding, the washing and cleaning agent moldings exhibit elevated stability. The breaking strength of cylindrical moldings can be determined by measuring the diametral fracture stress parameter, which may be determined according to—

$$σ = \frac{2 P}{π Dt}$$

σ here denotes diametral fracture stress (DFS) in Pa, P is the force in N which gives rise to the pressure exerted on the molding which causes fracture of the molding, D is the diameter of the molding in meters and t is the height of the molding.

In a further preferred embodiment, bi- or multiphasic washing or cleaning agents according to the invention are in the form of injection-molded dispensing units with two or more compartments separate from one another.

Injection molding here refers to forming a molding composition so that the composition held in a cylinder for more than one injection molding operation is plasticized by exposure to heat and flows under pressure through a nozzle into the cavity of a tool which has previously been closed. The method is primarily used with non-curable molding compositions which solidify in the tool by cooling. Injection molding is a very economical modern method of producing objects formed without machining and is particularly suitable for automated mass production. In practice, the thermoplastic molding compositions (powders, chips, cubes, pastes etc.) are heated until they liquefy (up to 180° C.) and then injected under elevated pressure (up to 140 MPa) into closed, preferably water-cooled, mold cavities which consist of two parts, namely the cavity plate (formerly female mold) and core (formerly male mold), where they cool and solidify. Both plunger and screw injection molding machines may be used. Suitable molding compositions (injection molding compositions) are water-soluble polymers such as for example cellulose ethers, pectins, polyethylene glycols, polyvinyl alcohols, polyvinyl pyrrolidones, alginates, gelatins or starch.

In a third preferred embodiment, bi- or multiphase washing or cleaning agents according to the invention are in the form of film pouches with two or more compartments which are separate from one another.

The film pouches are preferably obtained by thermoforming a film-like shell material. Thermoforming here preferably proceeds by placing the shell material over a receiving recess located in a female mold forming the thermoforming plane and then conforming the shell material to this receiving recess under the action of pressure and/or vacuum. Before or during conforming, the shell material may here be pretreated by the action of heat and/or solvent and/or conditioning under relative atmospheric humidity values and/or temperatures which differ from ambient conditions. The action of pressure may be applied by two parts of a tool, which behave as the positive and negative to one another and deform a film introduced between these tools when pressed together. Suitable pressing forces are, however, also the action of compressed air and/or the intrinsic weight of the film and/or the intrinsic weight of an active substance placed on the upper side of the film.

Suitable film materials include water-soluble polymers such as cellulose ethers, pectins, polyethylene glycols, polyvinyl alcohols, polyvinyl pyrrolidones, alginates, gelatins or starch.

The present application furthermore provides a method of cleaning dishes in a dishwashing machine using automatic dishwashing agents according to the invention, the automatic dishwashing agents preferably being dispensed into the interior of a dishwashing machine during the performance of a dishwashing program, before the start of the main washing cycle or in the course of the main washing cycle. Dispensing or introduction of the agent according to the invention into the interior of the dishwashing machine may proceed manually, but the agent is preferably dispensed into the interior of the dishwashing machine by means of the dispensing chamber of the dishwashing machine. Preferably, no additional water softener and no additional rinse aid is dispensed into the interior of the dishwashing machine in the course of the cleaning method. The present application also provides a kit for a dishwashing machine, comprising—
a) an automatic dishwashing agent according to the invention; and
b) instructions which instruct the consumer to use the automatic dishwashing agent without adding a rinse aid and/or a water-softening salt.

Automatic dishwashing agents according to the invention exhibit their advantageous cleaning characteristics in particular in low temperature cleaning methods. Preferred dishwashing methods using agents according to the invention are accordingly characterized in that said methods are carried out at temperatures of up to at most 55° C., preferably up to at most 50° C.

As described above, agents according to the invention are distinguished by improved cleaning performance on bleachable soiling in comparison with conventional automatic dishwashing agents. The present application accordingly furthermore provides the use of an automatic dishwashing agent according to the invention for improving bleaching performance in automatic dishwashing, in particular for removing tea stains.

### EXAMPLES

Soiled dishes were subjected to automatic cleaning in a dishwashing machine (Miele G 698) at a water hardness of 21 German hardness degrees and a temperature of 50° C., with 21 g of automatic dishwashing agents listed in the following table being used in the form of biphasic tablets—

| | | Comparison 1 | Invention 1 | Invention 2 | Invention 3 |
|---|---|---|---|---|---|
| | Ingredient | [wt. %] | [wt. %] | [wt. %] | [wt. %] |
| Phase [1] | Sodium percarbonate | 15 | 15 | 15 | 15 |
| | TAED | — | 3 | 3 | — |
| | Mn-Me₃-TACN complex | — | 0.05 | — | 0.05 |
| Phase [2] | Sodium percarbonate | — | — | — | — |
| | TAED | 3 | — | — | 3 |
| | Mn-Me₃-TACN complex | 0.05 | — | 0.05 | — |
| Phase [1] | Sodium tripolyphosphate | 30 | 30 | 30 | 30 |
| and/or [2] | Sodium carbonate | 12 | 12 | 12 | 12 |
| | HEDP | 2 | 2 | 2 | 2 |
| | Anionic copolymer | 20 | 20 | 20 | 20 |
| | Nonionic surfactant | 5 | 5 | 5 | 5 |
| | Protease preparation | 1.5 | 1.5 | 1.5 | 1.5 |
| | Amylase preparation | 1.5 | 1.5 | 1.5 | 1.5 |
| | Misc. | Ad 100 | Ad 100 | Ad 100 | Ad 100 |

| | | | | |
|---|---|---|---|---|
| Tea cleaning | 6.5 | 7.5 | 8.5 | 9 |

Tea cleaning by the automatic dishwashing agents was evaluated using the IKW method (tea cleaning evaluation scale: 10=no staining to 0=severe staining).

The stated values are mean values from cleaning tests carried out immediately after manufacture of the dishwashing agent tablets and after 4 weeks' storage.

We claim:

1. Bi- or multiphase washing or cleaning agent comprising
a) a bleaching agent
b) a bleach activator
c) a bleach catalyst selected from the group of bleach-boosting transition metal salts and transition metal complexes,
wherein the bleaching agent a) is present together with at least one of components b) or c) in one phase of the washing or cleaning agent.

2. Bi- or multiphase washing or cleaning agent according to claim 1 wherein bleaching agent a) is at least an oxygen bleaching agent.

3. Bi- or multiphase washing or cleaning agent according to claim 1 wherein bleaching agent a) is present in an amount of from 2 to 30 wt. %, based on total weight of the washing or cleaning agent.

4. Bi- or multiphase washing or cleaning agent according to claim 1 wherein bleach activator b) is at least an acetylated amine.

5. Bi- or multiphase washing or cleaning agent according to claim 1 wherein bleach activator b) is present in an amount of from 0.1 to 10 wt. %, based on total weight of the washing or cleaning agent.

6. Bi- or multiphase washing or cleaning agent according to claim 1, wherein bleach catalyst c) is at least a manganese complex.

7. Bi- or multiphase washing or cleaning agent according to claim 1, wherein bleach catalyst c) is present in an amount of from 0.001 to 3.0 wt. %, based on total weight of the washing or cleaning agent.

8. Bi- or multiphase washing or cleaning agent according to claim 1, wherein bleaching agent a) and bleach activator b) are present together in one phase of the washing or cleaning agent.

9. Bi- or multiphase washing or cleaning agent according to claim 1 wherein bleaching agent a) and bleach catalyst c) are present together in one phase of the washing or cleaning agent.

10. Bi- or multiphase washing or cleaning agent according to claim 1 wherein bleaching agent a), bleach activator b) and bleach catalyst c) are present together in one phase of the washing or cleaning agent.

11. Bi- or multiphasic washing or cleaning agent according to claim 1 further comprising at least one phosphonate present together with bleaching agent a) in one phase of the washing or cleaning agent.

12. Bi- or multiphase washing or cleaning agent according to claim 1, wherein the agent is in the form of a bi- or multilayer tablet.

13. Bi- or multiphase washing or cleaning agent according to claim 1, wherein the agent is in the form of an injection-molded dispensing unit having two or more compartments separate from one another.

14. Method of cleaning dishes in a dishwashing machine comprising washing the dishes using an agent according to claim 1.

15. Method according to claim 14 further comprising not dispensing any additional water softener or additional rinse aid into the interior of the dishwashing machine during the wash.
